(19) United States
(12) Patent Application Publication
(10) Pub. No.: US 2006/0076844 A1
(43) Pub. Date: Apr. 13, 2006

(54) Outer rotor type motor

(75) Inventor: Seoung Yong Han, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/245,052

(22) Filed: Oct. 7, 2005

(30) Foreign Application Priority Data
Oct. 8, 2004 (KR) 10-2004-0080251

(51) Int. Cl. H02K 5/00

(52) U.S. Cl. 310/91

(57) ABSTRACT

An outer rotor type motor provides a rotor of an outer rotor type motor with an optimal and simple structure that can be assembled easily. A rotation shaft is supported in a bearing housing and a stator is formed of a field winding. A rotor disposed outside the stator to house the stator therein, has a yoke surface on which a permanent magnet for performing a magnetic interaction with the filed winding of the stator is installed. The rotor rotates around the stator. A shaft bushing connects the rotor and the rotation shaft. The shaft bushing to be fastened to a central portion of the rotor is formed to have a polygonal shape to prevent a loss of a rotary power of the rotation shaft and has an insulation member for an electrical insulation of the motor.

### FIELD OF THE INVENTION

The present invention relates to a rotor of an outer rotor type motor; and, more particularly, to a rotor of an outer rotor type motor for use in a drum type washing machine, wherein the rotor is fabricated and assembled simply, thus improving productivity.

### BACKGROUND OF THE INVENTION

With regard to various driving methods for a motor, there is a motor type driven by an induced electromotive force (hereinafter, this motor type will be referred to as an electric induction motor). Such an electric induction motor is a kind of AC motor in which a rotary power is generated by an interaction between a rotating magnetic field generated in a stator and an inductive magnetic field generated in the rotor. Also, this electric induction motor is of a rotating magnetic field type.

The electric induction motor can be designed in various ways, i.e., it can be designed as a three-phase induction motor, a three-phase winding type induction motor and so forth as well as a single-phase induction motor. It is one of AC motors easy to use, so it has been widely employed in various household electric appliances.

Given that it has a constant rotational speed depending on a load imposed thereon and a long lifetime, the electric induction motor is adequate as a power supply motor. As a small-sized motor, in particular, a single-phase type capacitor motor has been most widely utilized.

The electric induction motor basically includes a housing; a stator fixed in the housing; and a rotator connected with a rotation shaft rotatably supported in the housing via a bearing. The stator generates an induced magnetism by receiving a power from outside via a winding coil, and the rotor rotates along with the rotation shaft due to the induced magnetism generated by the stator.

In the electric induction motor with the above-described configuration, an electric current is induced to a secondary winding by an electromagnetic induction of a primary winding which is connected to a power supply, and a rotary power is obtained by an interaction between the current induced at the secondary winding and a rotating magnetic field. Such an electric induction motor can be classified into an inner rotor type or an outer rotor type depending on relative locations of the stator and the rotor.

Recently, an outer rotor type induction motor having a rotor installed outside a stator has wide applications, because it is capable of increasing a torque at a same volume, and, by using the outer rotor type motor, it is possible to use the inner space of the stator for another purpose.

In the outer rotor type induction motor, a rotor having a driving shaft, a magnet, a rotor case, and so forth rotates outside a stator which is formed of an iron core, a core, a base, a bearing, and so forth. That is, the rotor rotates around the stator.

The rotor of the outer rotor type induction motor is illustrated in FIG. 1.

In the figure, a rotor 1 is made of a steel material and forms a casing of the motor by being press-molded. The rotor 1 includes a rotor core 2 and a rotor bushing 3. The rotor core 2 has a laminated iron core 2a which is press-fitted to the inner peripheral surface of the rotor 1 after being fabricated by blanking; and a ring-shaped ending member 2b installed at an upper and a lower end of the laminated core 2a. The rotor bushing 3 is for connecting the rotor 1 with a rotation shaft (not shown).

As mentioned, the rotor 1 employs the rotor bushing 3 to deliver its rotary power to the rotation shaft. The coupling of the rotor 1 and the rotor bushing 3 is illustrated in FIG. 2.

As shown in FIG. 2, the rotation shaft 4 is inserted into the rotor bushing 3 and is fixed to the rotator bushing 3 via a bolt 6. When the rotation shaft 4 and the rotor bushing 3 are connected to each other, the rotor bushing 3 is fastened to the rotor 1 via a fixing protrusion 7 or a bolt 8.

However, with regard to the above-described configuration of the rotor 1, the whole assembly process has been difficult because the rotor core 2 having the laminated iron core 2a and the ending members 2b need to be press-fitted to the rotor 1. Furthermore, since the rotor bushing 3 and the rotor 1 are connected via the additional volt 6, a fastening force therebetween may not be strong enough, resulting in a reduction in stability of the rotor 1.

### SUMMARY OF THE INVENTION

It is, therefore, an object of the present invention to provide a rotor of an outer rotor type motor with an optimal and simple structure that can be assembled easily, wherein the rotor is capable of stabilizing a transfer of its rotary power to a rotation shaft.

In accordance with a preferred embodiment of the present invention, there is provided an outer rotor type motor which includes a rotation shaft supported in a bearing housing; a stator formed of a field winding; a rotor disposed outside the stator to house the stator therein and having a yoke surface 15 on which a permanent magnet 20 for performing a magnetic interaction with the filed winding of the stator is installed, the rotor 10 rotating around the stator; and a shaft bushing 30 for connecting the rotor 10 and the rotation shaft 50, wherein the shaft bushing 30 to be fastened to a central portion of the rotor 10 is formed to have a polygonal shape to prevent a loss of a rotary power of the rotation shaft 50 and has an insulation member for an electrical insulation of the motor.

### BRIEF DESCRIPTION OF THE DRAWINGS

The above and other objects and features of the present invention will become apparent from the following description of preferred embodiments given in conjunction with the accompanying drawings, in which:

FIG. 1 is a perspective view of a conventional rotor;

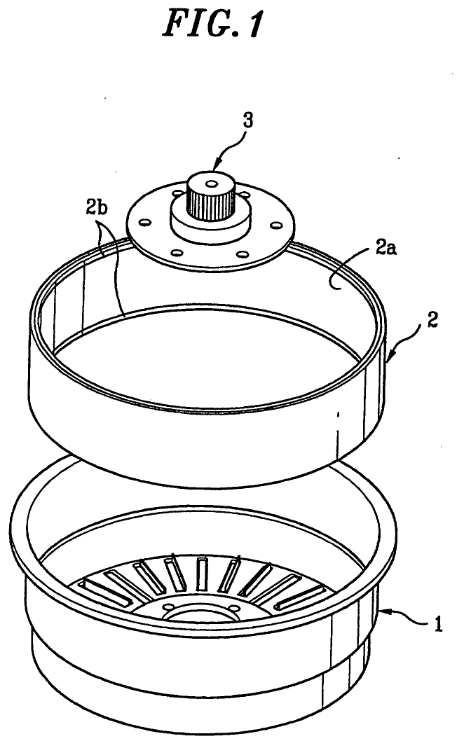

FIG. 2 sets forth a cross sectional view to illustrate the conventional rotor connected with a rotation shaft;

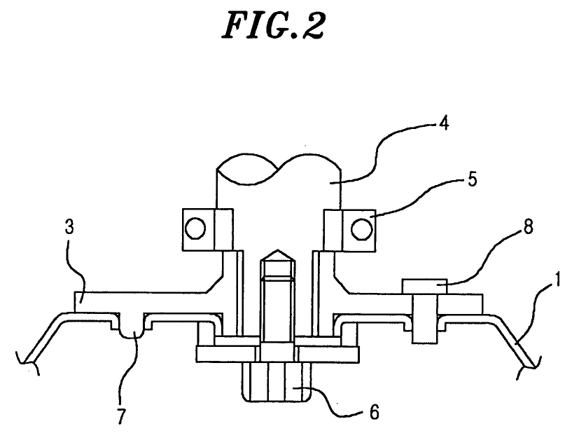

FIG. 3 presents a perspective view in accordance with the present invention; and

FIG. 4 depicts a cross sectional view to illustrate the rotor of the present invention connected with a rotation shaft.

### DETAILED DESCRIPTION OF THE PREFERRED EMBODIMENTS

The technical essence of the present invention resides in that a rotor for use in an outer rotor type commutatorless DC motor is fabricated to have a simple structure which is optimal in the aspect of strength and function of the rotor. Thus, manufacturing costs of the rotor can be reduced, and a stable transfer of a rotary power is enabled.

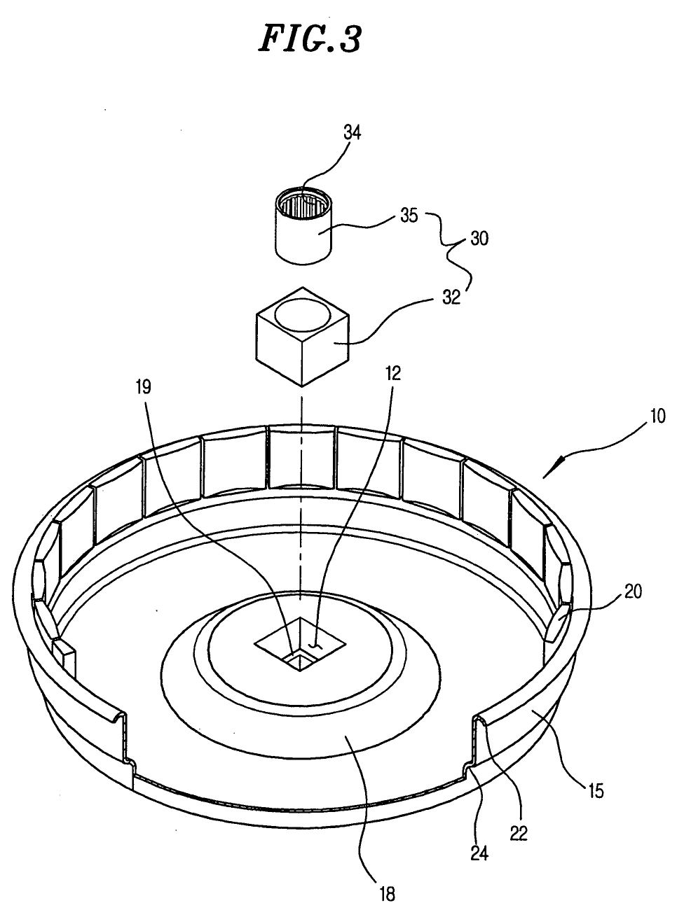

A rotor having such advantageous characteristics in accordance with the present invention is illustrated in FIG. 3.

A rotor 10 of an outer rotor type motor in accordance with the present invention is formed to have a cylindrical shape as a whole by press-molding an iron material. Substructures of the rotor 10 are formed through a simple post-process after the press-molding process.

Specifically, in the post-process for forming the substructures, an engagement hole 12 is formed in a base portion 18 of the rotor 10 of the cylindrical shape which is press-molded.

Then, a polygonal shaft bushing 30 for preventing a loss of a rotary power of a shaft is press-fitted into the engagement hole 12 or molded into the engagement hole 12 by insert-injection. The shaft bushing 30 also includes an insulating member for the electric insulation of the motor.

The shaft bushing 30 is configured to include a insulation portion 32 formed by injecting a polygonal resin material; and a bushing portion 35 press-fitted into the insulation portion 32 through a sinter-molding. The bushing portion 35 serves to receive the shaft 50 inserted thereinto. As mentioned above, the insulation portion 32 connected with the bushing portion 35 is fastened into the engagement hole 12 by press-fitting or insert-injection.

Meanwhile, formed inside the engagement hole 12 is a stepped portion 19 for confining an installation depth of the shaft bushing 30 inserted into the engagement hole 12.

Further, the bushing portion 35 of the shaft bushing 30 is provided on its inner peripheral surface with a serration 34. The presence of the serration 34 prevents a loss of a rotary power transferred to the shaft.

Also, a permanent magnet attachment surface 15 is extended along the inner sidewall of the rotor 10, and a permanent magnet 20 for performing a magnetic interaction with a field winding of a stator is attached to the permanent magnet attachment surface 10. At this time, the permanent magnet 20 is firmly attached to the permanent magnet attachment surface 15 by a bonding or the like such that it is not separated from the attachment surface 15 when the rotor 10 rotates.

Meanwhile, an outer end portion of the permanent magnet attachment surface 15 is curved outward, and a bent portion 22 is formed lower than the height of the permanent magnet 20. That is, the height between the base portion 18 and the bent portion 22 is delimited such that a part of the permanent magnet 15 projects higher than the top end of the permanent magnet attachment surface 15 when it is attached to the permanent magnet attachment surface 15. As a result, the permanent magnet 20 can be attached to the attachment surface 15 more firmly.

Further, an inclined surface 24 is formed at a joint portion between the permanent magnet attachment surface 15 and the base portion 18 of the rotor 10. The inclined surface 24 is provided to ease the control of the attachment position of the permanent magnet 20 when the magnet 20 is attached to the permanent magnet attachment surface 15.

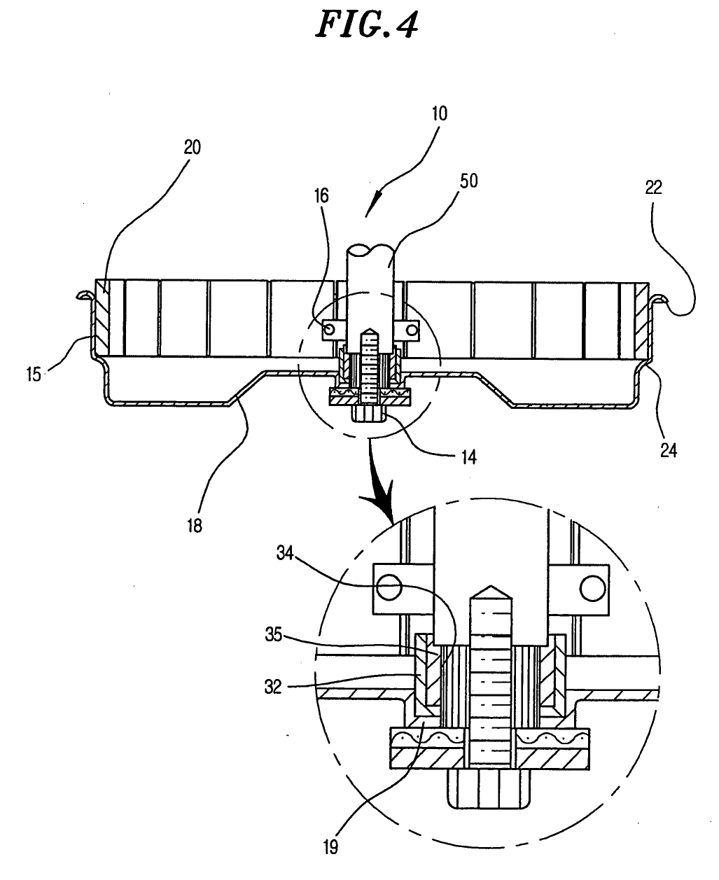

A fastening unit of a motor using the shaft bushing 30 configured as described above is illustrated in FIG. 4.

In FIG. 4, a driving motor for a drum type washing machine is employed as a power source for providing a high-output rotary power with a constant rotational speed. When the motor is installed in a main body of, e.g., a drum type washing machine, it is connected to a rotation shaft 50 of the washing machine which is extended downward from the washing machine main body.

The rotation shaft 50 is supported in a bearing housing 16 below the washing machine main body, and a joint bolt 6 is provided at an end portion of the rotation shaft 50.

The rotation shaft 50 is fastened to the rotor 10 for generating the rotary power of the motor via the joint bolt 14, which will be described in detail hereinbelow.

To connect the rotor 10 with the rotation shaft 50, the shaft 50 is inserted into the engagement hole 12 of the rotor 10 and is fixed therein by the joint bolt 14.

The rotation shaft 50 is engaged with the serration 34 provided on the inner peripheral surface of the bushing portion 30 inside the shaft bushing 30, so that the rotary power can be transferred between the rotor 10 and the rotation shaft 50 without suffering from a loss of the rotary power. The shaft bushing 30 having the insulation portion 32 and the bushing portion 35 is fitted into the engagement hole 12 with the bushing portion 35 inserted into the polygonal insulation portion 32 to be fixed therein. Further, when the shaft bushing 35 is fitted into the engagement hole 12, the installation depth thereof is confined by the presence of the stepped portion 19 in the lower portion of the engagement hole 12. That is, the shaft bushing 30 is prevented from being inserted too deeply below the base portion 18 of the rotor 10.

Moreover, the permanent magnet 20 attached to the inner wall surface of the cylindrical rotor 10 performs a magnetic interaction with a stator (not shown) disposed inside the rotor 10.

As described above, the rotor 10 is formed of the base portion 18 forming a bottom portion of the cylindrical body and the permanent magnet attachment surface 15 forming the vertical wall surface of the cylindrical body. The rotor 10 having this configuration can be simply fabricated by press-molding, and is installed inside the drum type washing machine.

By fitting the shaft bushing 30 into the engagement hole 12, the shaft bushing 50 is connected to the rotor 10, so that the rotary power of the rotor 10 can be transferred to the rotation shaft 50.

If the drum type washing machine is operated by the motor in which the above-described rotor 10 in accordance with the present invention is installed, the position of the permanent magnet 20 is set optimally by the presence of the inclined surface 24 on the permanent magnet attachment surface 15 of the rotor 10. Thus, the permanent magnet 20 is allowed to perform an optimal magnetic interaction with the stator, whereby the rotor 10 is made to rotate with an optimum rotary power, and its rotary power is delivered to the shaft bushing 30 connected with the engagement hole 12 as one body.

Meanwhile, by the presence of the bent portion 22 formed on the outer wall surface of the rotor 10, a strain that might be caused by the rotary power of the rotor 10 is prevented, so that the rotary power can be maintained stably.

Then, the rotary power delivered to the shaft bushing 30 is transferred to the rotation shaft 50 and, then, to a drum formed as one body with the rotation shaft 50, thus making the drum rotate. As a result of the rotation of the drum, washing of laundry accommodated in the drum is carried out.

Moreover, since the insulation portion 32 of the shaft bushing 30 is formed of a resin material, a current leakage that might occur during the rotation of the motor can be avoided and, also, a current leakage due to an electrical defect of the rotor 10 can be prevented.

As described above, since the rotor 10 of the motor for use in the drum type washing machine is formed by press-molding the base portion 18 and the lateral permanent magnet attachment surface 16 as one body, the fabrication of the rotor 10 becomes easier. Further, since the inclined surface 24 is provided on the permanent magnet attachment surface 15 of the rotor 10, the setting of the installation position of the permanent magnet also gets easier. In addition, by using the shaft bushing 30 including the insulation portion 32 formed of a resin material, a current leakage of the rotor 10 can be prevented.

In accordance with the present invention, a rotor for use in an outer rotor type commutatorless DC motor to be used in a drum type washing machine is fabricated to have a simple structure which is optimal in the aspect of strength and function. Thus, manufacturing costs of the rotor can be reduced, and a stable transfer of a rotary power is enabled. Moreover, a current leakage that might be caused by an electrical defect of the motor can be prevented, so that reliability of the drum type washing machine is improved.

While the invention has been shown and described with respect to the preferred embodiments, it will be understood by those skilled in the art that various changes and modifications may be made without departing from the spirit and scope of the invention as defined in the following claims.

What is claimed is:

1. An outer rotor type motor comprising:
a rotation shaft supported in a bearing housing;
a stator formed of a field winding;
a rotor disposed outside the stator to house the stator therein and having a yoke surface on which a permanent magnet for performing a magnetic interaction with the filed winding of the stator is installed, the rotor rotating around the stator; and
a shaft bushing for connecting the rotor and the rotation shaft,
wherein the shaft bushing to be fastened to a central portion of the rotor is formed to have a polygonal shape to prevent a loss of a rotary power of the rotation shaft and has an insulation member for an electrical insulation of the motor.

2. The motor of claim 1, wherein the shaft bushing includes:
an insulation portion formed by injection-molding a polygonal resin material; and
a bushing portion press-fitted into the insulation portion by sinter-molding, for receiving the rotation shaft inserted thereinto,
wherein the insulation portion is inserted into an engagement hole formed at the central portion of the rotor to be fixed therein.

3. The motor of claim 1, wherein the shaft bushing is fastened into the engagement hole by inert-molding or press-fitting.

4. The motor of claim 2, wherein a stepped portion for confining an installation depth of the shaft bushing inserted into the engagement hole is formed inside the engagement hole.

5. The motor of claim 3, wherein a stepped portion for confining an installation depth of the shaft bushing inserted into the engagement hole is formed inside the engagement hole.
